(19) United States
(12) Patent Application Publication
(10) Pub. No.: US 2012/0188144 A1
(43) Pub. Date: Jul. 26, 2012

(54) PRINTED ANTENNA AND TERMINAL DEVICE

(75) Inventors: Daduo Chen, Shenzhen (CN); Zhonghua Li, Shenzhen (CN)

(73) Assignee: Huawei Device Co.,Ltd., Shenzhen (CN)

(21) Appl. No.: 13/434,506

(22) Filed: Mar. 29, 2012

Related U.S. Application Data
(63) Continuation of application No. PCT/CN2010/074302, filed on Jun. 23, 2010.

(30) Foreign Application Priority Data
Sep. 29, 2009 (CN) 200920205511.1

(51) Int. Cl. H01Q 21/00; H01Q 1/38

(52) U.S. Cl. 343/893; 343/700 MS

(57) ABSTRACT

Embodiments of the present invention relate to the field of electronic communication, and more particularly, to a printed antenna and a terminal device comprising said printed antenna. Said printed antenna includes a printed circuit board and at least two antenna patterns; said printed circuit board includes at least two copper foil layers; said at least two antenna patterns are formed on different copper foil layers of said printed circuit board respectively, and said at least two antenna patterns are electrically connected to each other. Since said printed antenna includes a plurality of monolayer antenna patterns, said antenna has a stable performance index and less dependent on the parameters of said printed circuit board, such as the thickness, thereby greatly improving the performance and communication quality of the terminal device's antenna.

### CROSS-REFERENCE TO RELATED APPLICATIONS

This application is a continuation of International Application No. PCT/CN2010/074302, filed on Jun. 23, 2010, which claims priority to Chinese Patent Application No. 200920205511.1, filed on Sep. 29, 2009, both of which are hereby incorporated by reference in their entireties.

### FIELD OF THE INVENTION

The present invention relates to a field of electronic communication, and particularly, to a printed antenna and a terminal device comprising the printed antenna.

### BACKGROUND OF THE INVENTION

The conventional data card usually adopts an external antenna or an internal antenna. For the external antenna, external elements shall be added and interfaces shall be reserved on the terminal device. As a result, the interfaces for the extended antenna are required while the peripheral elements are added. For the internal antenna, the number of elements shall be increased, the costs of assembly, test and cost shall be increased, a larger space shall be occupied, and the appearance design for the data card is limited to some extent.

In addition, the solution of monolayer printing for the printed antenna is adopted by some data cards. With the solution that adopts the printed antenna, the size of the data card may be made smaller, and the development space is saved while a good appearance design effect is achieved.

During the implementation of the present invention, the inventor has found that the prior art at least has the following defects: in the prior art, the solution of monolayer printed antenna is influenced by the factors such as the thickness tolerance and the dielectric constant of the Printed Circuit Board (PCB) during actual mass production, and thus the antenna index will be affected, which is adverse to the mass production of products.

### SUMMARY OF THE INVENTION

One aspect of embodiments of the present invention provides a printed antenna, and the other aspect thereof provides a terminal device, which is capable of solving the problem of index deviation in the existing solution of monolayer printed antenna during mass production.

The printed antenna according to the embodiments of the present invention includes: a Printed Circuit Board (PCB) and at least two antenna patterns; the PCB comprises at least two copper foil layers; the at least two antenna patterns are formed on different copper foil layers of the PCB respectively, and said at least two antenna patterns are electrically connected to each other.

The terminal device according to the embodiments of the present invention includes: the printed antenna mentioned above and a communication module; the communication module is configured to access a wireless network through the printed antenna, thereby realizing communication between the terminal and the wireless network.

From the above solutions, it can be seen that in the embodiments of the present invention, at least two antenna patterns are formed on different copper foil layers of the PCB and said at least two antenna patterns are electrically connected to each other, thereby forming a printed antenna including a plurality of monolayer antenna patterns. Since the printed antenna includes a plurality of monolayer antenna patterns, the antenna has a stable performance index and is less dependent on the parameters of the PCB, such as the thickness, thereby greatly improving the performance and communication quality of the terminal device's antenna.

### BRIEF DESCRIPTION OF THE DRAWINGS

In order to more clearly describe the solutions of the embodiments of the present invention, the drawings required to be used in the embodiments will be briefly introduced below. Obviously, the drawings in the following description just illustrate some embodiments of the present invention, and a person skilled in the art can also obtain other drawings from these drawings without paying any creative effort.

FIG. 1 is a stereo structure diagram of an antenna according to the embodiment of the present invention;

FIGS. 2a, 2b and 2c are hierarchical structure diagrams of another printed antenna according to the embodiment of the present invention;

FIGS. 3a to 3d are shape diagrams of the antenna patterns according to the embodiments of the present invention; and

FIG. 4 is a structure diagram of a terminal device according to the embodiment of the present invention.

### DETAILED DESCRIPTION OF THE PREFERRED EMBODIMENTS

The solutions of the embodiments of the present invention will be clearly and completely described below with reference to the drawings in the embodiments of the present invention. Obviously, the described embodiments are just part of the embodiments of the present invention rather than all the embodiments. Based on the embodiments of the present invention, any other embodiment obtained by a person skilled in the art without paying any creative effort shall fall within the protection scope of the present invention.

### Embodiment 1

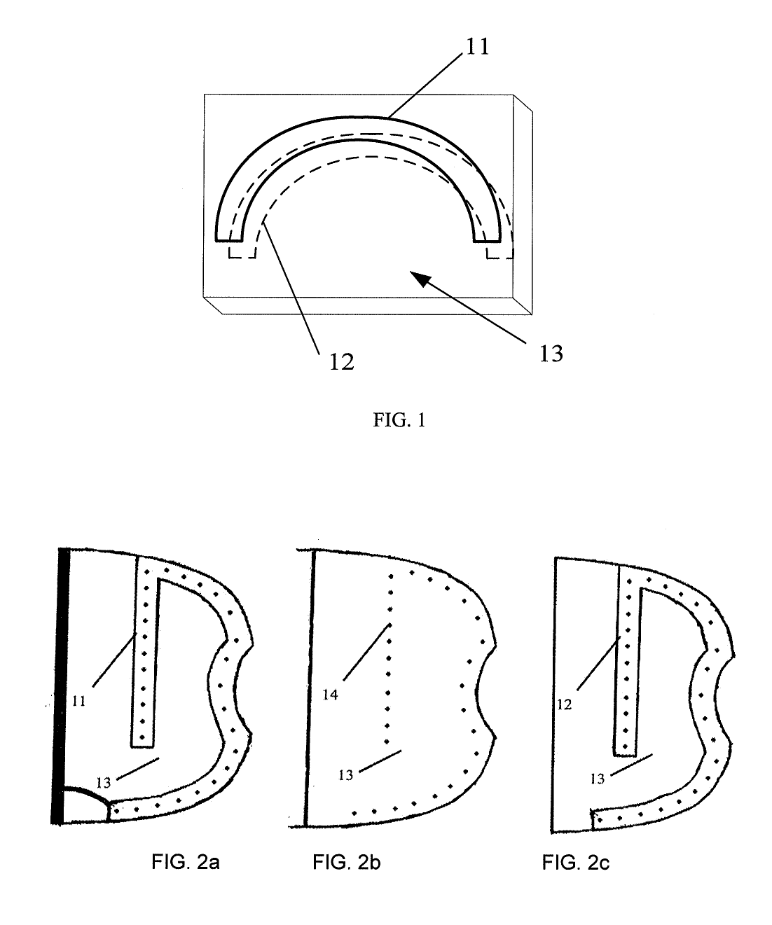

As illustrated in FIG. 1, the embodiment of the present invention provides a printed antenna, including a first antenna pattern 11 (the strip antenna indicated by the solid lines in FIG. 1), a second antenna pattern 12 (the strip antenna indicated by the dashed lines in FIG. 1) and a PCB 13.

The PCB 13 includes at least two copper foil layers.

The first antenna pattern 11 and the second antenna pattern 12 are formed on different copper foil layers of the PCB 13 respectively, and said at least two antenna patterns are electrically connected to each other (not illustrated in FIG. 1).

Referring to FIG. 1, which is a stereo diagram of the printed antenna, the first antenna pattern 11 is formed on the top copper foil layer of the PCB 13, and the second antenna pattern 12 may be formed on the bottom or intermediate copper foil layer of the PCB 13. In case that the PCB 13 is a double-sided board, the first antenna pattern 11 and the second antenna pattern 12 may be formed on the top layer and the bottom layer of the PCB 13 respectively. In case that the PCB 13 is a multi-layer board, the first antenna pattern 11 and the second antenna pattern 12 may be formed on any two of the top layer, the bottom layer and the intermediate layer of the PCB 13 respectively; for example, the first antenna pattern 11 is formed on the top layer of the PCB 13, and the second antenna pattern 11 is formed on the bottom layer or the intermediate layer of the PCB 13.

In addition, in case that the PCB 13 is a multi-layer board, the printed antenna is not limited to including only two antenna patterns (the first antenna pattern 11 and the second antenna pattern 12). That is, the printed antenna may further include the third antenna pattern, the fourth antenna pattern, etc. till the N^{th} antenna pattern, wherein N is less than or equal to the number of the copper foil layers of the PCB 13. In other words, in case that the PCB 13 is a multi-layer board, at least two copper foil layers may be randomly selected from the top layer, the bottom layer and at least one of the intermediate layers of the PCB 13 to form antenna patterns respectively (e.g., three layers, four layers, . . . , till each of the layers is formed with an antenna pattern), and the antenna patterns of the respective layers are electrically connected to each other.

Wherein, referring to FIGS. 2a, 2b and 2c (FIGS. 2a, 2b and 2c are hierarchical diagrams, which are top views of respective layers viewed downward from the top layer of the PCB 13), the first antenna pattern 11 and the second antenna pattern 12 may have same or similar shapes, and are correspondingly provided on different copper foil layers of the PCB 13 (e.g., the projections of the first antenna pattern 11 and the second antenna pattern 12 on the horizontal plane corresponding to a certain layer of the PCB 13 are completely or partially overlapped with each other), so that the first antenna pattern 11 and the second antenna pattern 12 are electrically connected to each other through one or more via holes 14 with a conductive material laid therein. In FIGS. 2a, 2b and 2c, the first antenna pattern 11 is formed on the top layer of the PCB 13, and the second antenna pattern 12 is formed on the bottom layer of the PCB 13. FIG. 2b illustrates the via hole 14 in the intermediate layer, wherein the via hole 14 penetrates the top layer, the intermediate layer and the bottom layer of the PCB 13, and passes through the first antenna pattern 11 and the second antenna pattern 12. In addition, the via hole 14 should be one or more via holes, and the specific number is not limited and may be set as required, so long as to electrically connect the first antenna pattern 11 and the second antenna pattern 12. In case that there are more via holes 14, they should be arranged uniformly or randomly. In case that there are more via holes 14, the effect of their electric connection will be better. In case that the PCB 13 is a multi-layer board, the printed antenna may include a plurality of antenna patterns (e.g., the first antenna pattern 11, the second antenna pattern 12, the third antenna pattern, the fourth antenna pattern, etc., till the N^{th} antenna pattern), which may have the same or similar shapes and are correspondingly provided on different copper foil layers of the PCB 13 respectively (e.g., the projections of the antenna patterns of respective layers on the horizontal plane corresponding to a certain layer of the PCB 13 are completely or partially overlapped with each other), so that the antenna patterns distributed on the respective layers are electrically connected to each other through the via holes with a conductive material laid therein.

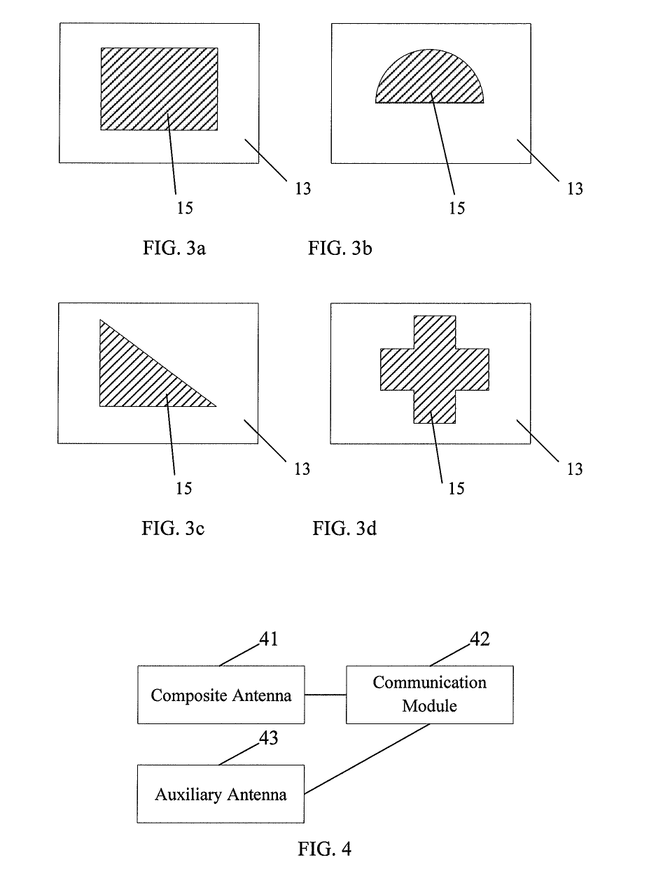

Of course, the electrical connections between the antenna patterns of different layers are not limited to the above connection of via holes, and may be other forms of electrical connection. The shapes of the antenna patterns should be regular or irregular strip, regular or irregular bulk or other regular or irregular shapes, and should be specificly set as required. In addition, the antenna patterns of different layers may have different shapes, e.g., the first antenna pattern 11 may be of a regular or irregular strip shape as illustrated in FIG. 1 or 2a, while the third antenna pattern may be a rectangular, semicircular, triangular or other regular or irregular shape as illustrated in FIGS. 3a to 3d.

In the embodiment of the present invention, at least two antenna patterns are formed on different copper foil layers of the PCB and said at least two antenna patterns are electrically connected to each other, thereby forming a printed antenna including a plurality of monolayer antenna patterns. Since the printed antenna includes a plurality of monolayer antenna patterns, i.e., the patterns of the antenna pattern are designed into a plurality of layers, the antenna has a relatively stable performance index when the thickness of the PCB is changed, and the dependency of the antenna on the parameters of the PCB, such as the thickness, is greatly reduced. As compared with the existing solution of monolayer printed antenna, the printed antenna according to the embodiment of the present invention greatly improves the antenna's performance. Furthermore, since the printed antenna according to the embodiment of the present invention solves the problem of index deviation of the existing solution of monolayer printed antenna during mass production, the printed antenna according to the embodiment of the present invention has a stable performance during mass production. Therefore, the printed antenna according to the embodiment of the present invention is especially suitable for mass production for antennas in the industry.

### Embodiment 2

As illustrated in FIG. 4, the embodiment of the present invention provides a terminal device, including a printed antenna 41 and a communication module 42.

The printed antenna 41 includes a PCB and at least two antenna patterns. The PCB includes at least two copper foil layers. The at least two antenna patterns are formed on different copper foil layers of the PCB respectively, and said at least two antenna patterns are electrically connected to each other.

The communication module 42 is configured to access a wireless network through the printed antenna 41, so as to realize communication between the terminal and the wireless network.

The terminal device may further include an auxiliary antenna 43 configured to perform a signal diversity reception in cooperation with a primary antenna. In this case, the printed antenna 41 serves as the primary antenna, and the auxiliary antenna 43 may also adopt a form similar to the form of the printed antenna 41, i.e., the auxiliary antenna 43 may also be a printed antenna including at least two antenna patterns.

Please refer to the description in Embodiment 1 for the implementation of the printed antenna 41, and herein is omitted.

The terminal device may be a data card (wireless modem), a wireless network card, a cell phone, a portable computer with Internet access function, or other terminal devices capable of mobile communication. In addition, the printed antenna 41 may also be used to realize the functions such as Bluetooth, Wireless Fidelity (WIFI), Navigation Satellite Timing And Ranging Global Position System (GPS) and so on.

In the embodiment of the present invention, at least two antenna patterns are formed on different copper foil layers of the PCB and said at least two antenna patterns are electrically connected to each other, thereby forming a printed antenna including a plurality of monolayer antenna patterns. Since the printed antenna includes a plurality of monolayer antenna patterns, the antenna has a stable performance index and less dependent on the parameters of the PCB, such as the thickness, thereby greatly improving the performance and the communication quality of the terminal device' antenna.

In a word, the above descriptions are only the preferred embodiments of the present invention, and are not intended to limit the protection scope of the present invention. Any change, equivalent replacement, improvement, etc. made within the spirit and principle of the present invention shall be covered by the protection scope of the present invention.

1. An antenna, comprising:
a printed circuit board and at least two antenna patterns;
wherein said printed circuit board comprises at least two copper foil layers; and
said at least two antenna patterns are respectively disposed on different copper foil layers of said printed circuit board respectively and said at least two antenna patterns are electrically connected to each other.

2. The antenna according to claim 1, wherein said at least two antenna patterns comprise a first antenna pattern and a second antenna pattern, said first antenna pattern disposed on the top layer of said printed circuit board, and said second antenna pattern disposed on the intermediate layer or the bottom layer of said printed circuit board.

3. The antenna according to claim 1, wherein said at least two antenna patterns are correspondingly arranged on different copper foil layers of said printed circuit board, and said printed circuit board is formed with one or more via holes, said via holes pass through said at least two antenna patterns and realize the electrical connection between said at least two antenna patterns through a conductive material laid in said via holes.

4. The antenna according to claim 2, wherein said at least two antenna patterns are correspondingly arranged on different copper foil layers of said printed circuit board, and said printed circuit board is formed with one or more via holes, said via holes pass through said at least two antenna patterns and realize the electrical connection between said at least two antenna patterns through a conductive material laid in said via holes.

5. The antenna according to claim 1, wherein each comprises a strip shape or a bulk shape.

6. The antenna according to claim 2, wherein said antenna patterns each comprises a strip shape or a bulk shape.

7. The antenna according to claim 1, wherein said at least two antenna patterns have same shape.

8. A terminal device, comprising:
a printed antenna and a communication module;
wherein said printed antenna is configured to comprise:
a printed circuit board and at least two antenna patterns;
said printed circuit board comprises at least two copper foil layers; and
said at least two antenna patterns are respectively disposed on different copper foil layers of said printed circuit board respectively and said at least two antenna patterns are electrically connected to each other.
said communication module is configured to access a wireless network through said printed antenna, thereby realizing communication between said terminal device and said wireless network.

9. The terminal device according to claim 8, further comprising an auxiliary antenna;
said printed antenna serves as a primary antenna of said terminal device; and
said auxiliary antenna is configured to serve as a diversity antenna of said terminal device and perform a signal diversity reception in cooperation with said primary antenna.

10. The terminal device according to claim 9, wherein said auxiliary antenna comprises a printed antenna comprising at least two antenna patterns.

11. The terminal device according to claim 8, wherein said terminal device comprises one of the following: a data card, a wireless network card, a cell phone, and a portable computer with Internet access function.

12. The terminal device according to claim 9, wherein said terminal device comprises one of the following: a data card, a wireless network card, and a cell phone, a portable computer with Internet access function.

13. The terminal device according to claim 10, wherein said terminal device comprises one of the following: a data card, a wireless network card, a cell phone, a portable computer with Internet access function.

14. The antenna according to claim 1, wherein said at least two antenna patterns have different shapes from each other.

15. The terminal device according to claim 8, wherein said terminal device comprises a terminal device capable of mobile communication.

16. The terminal device according to claim 9, wherein said terminal device comprises a terminal device capable of mobile communication.

17. The terminal device according to claim 10, wherein said terminal device comprises a terminal device capable of mobile communication.
